(19) United States
(12) Patent Application Publication
(10) Pub. No.: US 2024/0116047 A1
(43) Pub. Date: Apr. 11, 2024

(54) Liquid Reservoirs, Cartridge Assemblies and Related Systems and Methods

(71) Applicants: ILLUMINA, INC., San Diego, CA (US); Illumina Singapore PTE. LTD., Singapore (SG)

(72) Inventors: Panteleimon Athanasiou, Oceanside, CA (US); Beng Keong Ang, Singapore (SG); Justin Davidson, Solana Beach, CA (US); Norman Khoo, San Diego, CA (US); Heng Kuang Cheng, Singapore (SG); Hao Yu, Singapore (SG); Zhenning Cao, San Diego, CA (US)

(21) Appl. No.: 18/375,205

(22) Filed: Sep. 29, 2023

Related U.S. Application Data
(60) Provisional application No. 63/412,075, filed on Sep. 30, 2022.

(51) Int. Cl. B01L 3/00

(52) U.S. Cl. CPC B01L 3/502715; B01L 3/502723; B01L 2200/0684; B01L 2200/0689

(57) ABSTRACT

Liquid reservoirs, cartridge assemblies and related systems and methods are disclosed. An example implementation includes an apparatus that includes a body, a cover, and a lid assembly. The body includes a top surface and a storage chamber having an opening at the top surface. The cover covers or is positioned within the opening of the storage chamber. The lid assembly is coupled to the top surface and covers the opening of the storage chamber. The top surface and the first portion define a plenum. The cover is at least one of piercable, breakable, or movable to allow the storage chamber to be fluidly coupled to the plenum without venting the plenum to atmosphere.

### RELATED APPLICATION

This application claims the benefit of and priority to U.S. Provisional Patent Application No. 63/412,075, filed Sep. 30, 2022, the content of which is incorporated by reference herein in its entireties and for all purposes.

### BACKGROUND

Sequencing platforms may include sippers that pierce a cover of a reagent reservoir and draw reagent from the reagent reservoir.

### SUMMARY

Advantages over the prior art and benefits as described later in this disclosure can be achieved through the provision of reagent reservoirs and related systems and methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, an apparatus includes a system, a liquid reservoir, and a cartridge assembly. The system includes a pneumatic interface; an actuator; and a receptacle. The liquid reservoir is receivable within the receptacle and has a body, a cover, and a lid assembly. The body includes a top surface, a storage chamber having an opening at the top surface, a sipper chamber having an opening at the top surface, and a fluidic sinus fluidly coupling the storage chamber and the sipper chamber. The cover covers the opening of the storage chamber and the lid assembly is coupled to the top surface and has a first portion covering the opening of the storage chamber and a second portion covering the opening of the sipper chamber. The top surface and the first portion define a plenum. The first portion includes a pneumatic port fluidly coupled to the plenum, a cantilever having a distal end, and a compliant barrier covering the cantilever and defining a portion of the plenum. The second portion includes a fluidic port fluidly coupled to the opening of the sipper chamber. The cartridge assembly includes a fluidic interface couplable to the fluidic port, a well, and a channel fluidly coupled between the fluidic interface and the well. The actuator is movable to engage the compliant barrier and move the distal end of the cantilever to pierce the cover and allow the storage chamber to be fluidly coupled to the plenum.

In accordance with a second implementation, an apparatus includes a body, a cover, and a lid assembly. The body includes a top surface, a storage chamber having an opening at the top surface, a sipper chamber having an opening at the top surface, and a fluidic sinus fluidly coupling the storage chamber and the sipper chamber. The cover covers the opening of the storage chamber. The lid assembly is coupled to the top surface and has a first portion covering the opening of the storage chamber and a second portion covering the opening of the sipper chamber. The top surface and the first portion define a plenum. The first portion includes a pneumatic port fluidly coupled to the plenum, a cantilever having a distal end, and a compliant barrier covering the cantilever and defining a portion of the plenum. The second portion includes a fluidic port fluidly coupled to the opening of the sipper chamber. The compliant barrier and the cantilever are movable to enable the distal end of the cantilever to pierce the cover and allow the storage chamber to be fluidly coupled to the plenum.

In accordance with a third implementation, an apparatus includes a body, a cover, and a lid assembly. The body includes a top surface, a storage chamber having an opening at the top surface, a sipper chamber having an opening at the top surface, and a fluidic sinus fluidly coupling the storage chamber and the sipper chamber. The cover covers the opening of the storage chamber. The lid assembly is coupled to the top surface and has a first portion covering the opening of the storage chamber and a second portion covering the opening of the sipper chamber. The top surface and the first portion define a plenum. The first portion includes a pneumatic port fluidly coupled to the plenum and a compliant barrier covering the cover and defining a portion of the plenum. The second portion includes a fluidic port fluidly coupled to the opening of the sipper chamber. The compliant barrier is movable to enable the cover to be pierced and allow the storage chamber to be fluidly coupled to the plenum.

In accordance with a fourth implementation, an apparatus includes a body, a cover, and a lid assembly. The body includes a top surface, a storage chamber having an opening at the top surface, a sipper chamber having an opening at the top surface, and a fluidic sinus fluidly coupling the storage chamber and the sipper chamber. The cover includes a frangible portion and cover the opening of the storage chamber. The lid assembly is coupled to the top surface and has a first portion covering the opening of the storage chamber and a second portion covering the opening of the sipper chamber. The top surface and the first portion define a plenum. The first portion includes a pneumatic port fluidly coupled to the plenum and the second portion includes a fluidic port fluidly coupled to the opening of the sipper chamber. The plenum is to be pressurized to break the frangible portion and allow the storage chamber to be fluidly coupled to the plenum.

In accordance with a fifth implementation, an apparatus includes a body, a plug, and a lid assembly. The body includes a top surface, a storage chamber having an opening at the top surface, a sipper chamber having an opening at the top surface, and a fluidic sinus fluidly coupling the storage chamber and the sipper chamber. The plug is disposed in and seals the opening of the storage chamber. The lid assembly is coupled to the top surface and has a first portion covering the opening of the storage chamber and a second portion covering the opening of the sipper chamber. The top surface and the first portion define a plenum. The first portion includes a pneumatic port fluidly coupled to the plenum and the second portion includes a fluidic port fluidly coupled to the opening of the sipper chamber. The plenum is to be pressurized to urge the plug to move within the opening and allow the storage chamber to be fluidly coupled to the plenum.

In accordance with a sixth implementation, a method includes engaging a compliant barrier of a lid assembly of a liquid reservoir. The liquid reservoir includes a body, a cover, and a lid assembly. The body includes a top surface and a storage chamber having an opening at the top surface. The cover covers the opening of the storage chamber. The lid assembly is coupled to the top surface and covers the opening of the storage chamber. The top surface and the lid assembly define a plenum. The lid assembly includes a cantilever having a distal end and the compliant barrier covers the cantilever and defines a portion of the plenum. The method includes moving the distal end of the cantilever toward the cover and piercing the cover with the distal end of the cantilever to allow the storage chamber to be fluidly coupled to the plenum.

In accordance with a seventh implementation, a method includes engaging a compliant barrier of a lid assembly of a liquid reservoir. The liquid reservoir includes a body, a cover, and the lid assembly. The body includes a top surface and a storage chamber having an opening at the top surface. The cover covers the opening of the storage chamber. The lid assembly is coupled to the top surface and covers the opening of the storage chamber. The top surface and the lid assembly define a plenum. The lid assembly includes the compliant barrier that defines a portion of the plenum. The method includes moving the compliant barrier toward the cover and piercing the cover to allow the storage chamber to be fluidly coupled to the plenum.

In accordance with an eighth implementation, a method includes pressurizing a plenum of a liquid reservoir. The liquid reservoir includes a body, a cover, and a lid assembly. The body includes a top surface and a storage chamber having an opening at the top surface. The cover includes a frangible portion covering the opening of the storage chamber. The lid assembly is coupled to the top surface and covers the opening of the storage chamber. The method includes breaking the frangible portion in response to pressurizing the plenum to allow the storage chamber to be fluidly coupled to the plenum.

In accordance with a ninth implementation, a method includes pressurizing a plenum of a liquid reservoir. The liquid reservoir includes a body, a lid assembly, and a plug. The body includes a top surface and a storage chamber having an opening at the top surface. The lid assembly is coupled to the top surface and covers the opening of the storage chamber. The plug is disposed in and seals the opening of the storage chamber. The top surface and the lid assembly define the plenum. The method includes urging the plug to move within the opening in response to pressurizing the plenum to allow the storage chamber to be fluidly coupled to the plenum.

In accordance with a tenth implementation, an apparatus includes a body, a cover, and a lid assembly. The body includes a top surface and a storage chamber having an opening at the top surface. The cover covers or is positioned within the opening of the storage chamber. The lid assembly coupled to the top surface and covers the opening of the storage chamber. The top surface and the first portion defining a plenum. The cover is at least one of piercable, breakable, or movable to allow the storage chamber to be fluidly coupled to the plenum without venting the plenum to atmosphere.

In further accordance with the foregoing first, second, third, fourth, fifth, sixth, seventh, eighth, ninth, and tenth implementations, an apparatus and/or method may further comprise or include any one or more of the following:

In accordance with an implementation, the engagement between the actuator and the compliant barrier does not vent the plenum to atmosphere.

In accordance with another implementation, the apparatus includes liquid contained within the storage chamber.

In accordance with another implementation, the apparatus includes dried reagent contained within the well.

In accordance with another implementation, the cartridge assembly includes a flow cell.

In accordance with another implementation, the cover includes foil.

In accordance with another implementation, the compliant barrier includes an elastomer.

In accordance with another implementation, the compliant barrier includes conformable foil.

In accordance with another implementation, the body of the liquid reservoir includes a port having a distal end and defining the opening and the cover is coupled to the distal end of the port.

In accordance with another implementation, the lid assembly includes a body including the cantilever and the compliant barrier is coupled to the body covering the cantilever.

In accordance with another implementation, the body includes a living hinge coupled to the cantilever.

In accordance with another implementation, the distal end of the cantilever includes a protrusion.

In accordance with another implementation, the protrusion includes an oblique cone.

In accordance with another implementation, the pneumatic interface includes a bore, a coupling movably positioned within the bore, and a biasing element. The biasing element to urge the coupling into sealing engagement with the pneumatic port of the lid assembly.

In accordance with another implementation, the fluidic interface of the reagent cartridge includes a hollow protrusion that is positionable within the fluidic port of the lid assembly to fluidly couple to the liquid reservoir and the cartridge assembly.

In accordance with another implementation, a side of the body defines an outward-facing groove. The apparatus further includes a cover secured to the side of the body. The groove and the cover defining the sipper chamber.

In accordance with another implementation, the body includes a second storage chamber having an opening at the top surface, a second sipper chamber having an opening at the top surface, and a second fluidic sinus fluidly coupling the second storage chamber and the second sipper chamber.

In accordance with another implementation, the first portion of the lid assembly covers the opening of the second storage chamber and the second portion of the lid assembly covers the opening of the second sipper chamber. The first portion includes a second cantilever having a distal end and a second compliant barrier covering the second cantilever and defining a portion of the plenum. The second portion includes a second fluidic port fluidly coupled to the opening of the second sipper chamber.

In accordance with another implementation, the body and the lid assembly include a manifold including the plenum, the opening of the storage chamber, and the opening of the second storage chamber.

In accordance with another implementation, the lid assembly includes a pair of locating pins and the body includes a pair of corresponding locating holes.

In accordance with another implementation, the apparatus includes a housing in which the body is disposed. The housing has an end defining an opening. The lid assembly is positioned within the housing and accessible via the opening.

In accordance with another implementation, the apparatus includes a housing cover coupled the housing and retaining the body and the lid assembly within the housing.

In accordance with another implementation, the apparatus includes a snap-fit connection formed between the housing cover and the housing.

In accordance with another implementation, the housing cover defines an aperture enabling access to the compliant barrier when the housing cover is coupled to the housing.

In accordance with another implementation, the lid assembly includes a body defining an opening and the compliant barrier is coupled to the body and covers the opening.

In accordance with another implementation, the compliant barrier includes an outer wall, a central portion, and a groove at least partially surrounding the central portion. The outer wall is coupled to the body surrounding the aperture.

In accordance with another implementation, the compliant barrier includes a U-shaped portion that couples the outer wall and the central portion. The U-shaped portion, the outer wall, and the central portion defining the groove.

In accordance with another implementation, the central portion includes an outwardly tapered U-shaped wall that defines the groove.

In accordance with another implementation, the central portion includes a lower surface and the compliant barrier has a portion defining the groove that is vertically spaced from the lower surface and positioned closer to the cover covering the opening of the storage chamber.

In accordance with another implementation, the compliant barrier includes an outer portion and a central portion that is vertically spaced from the outer portion. The outer portion is coupled to the body surrounding the opening.

In accordance with another implementation, the lid assembly includes a body including the cantilever and the compliant barrier is coupled to the body covering the cantilever.

In accordance with another implementation, the cantilever includes the distal end, a necked portion, and a proximal end. The body includes a living hinge coupled to the proximal end of the cantilever.

In accordance with another implementation, the distal end has an oblong portion.

In accordance with another implementation, the cantilever has a tapered surface that extends between the necked portion and the living hinge.

In accordance with another implementation, the distal end has a first thickness and the proximal end has a second thickness that is less than the first thickness.

In accordance with another implementation, the distal end of the cantilever includes a protrusion.

In accordance with another implementation, the protrusion defines a cut-out defining a vent.

In accordance with another implementation, the protrusion includes a polyhedron.

In accordance with another implementation, the protrusion includes an edge and a tip.

In accordance with another implementation, the compliant barrier being pierced does not vent the plenum to atmosphere.

In accordance with another implementation, the compliant barrier includes conformable foil.

In accordance with another implementation, the frangible portion includes a line of weakness.

In accordance with another implementation, the frangible portion breaking does not vent the plenum to atmosphere.

In accordance with another implementation, the body includes a step to be engaged by the plug.

In accordance with another implementation, piercing the cover with the distal end of the cantilever does not vent the plenum to atmosphere.

In accordance with another implementation, the method includes coupling a fluidic interface of a cartridge assembly with a fluidic port of the liquid reservoir. The liquid reservoir has a body defining the storage chamber, a sipper chamber, and a fluidic sinus fluidly coupling the storage chamber and the sipper chamber. The method also includes flowing liquid from the storage chamber through the sipper chamber and the fluidic port to the fluidic interface.

In accordance with another implementation, the method includes rehydrating dried reagent contained within a well of the cartridge assembly with the liquid. The cartridge assembly includes the well, the fluidic interface, and a channel fluidly coupled between the fluidic interface and the well.

In accordance with another implementation, piercing the cover does not vent the plenum to atmosphere.

In accordance with another implementation, the compliant barrier includes conformable foil.

In accordance with another implementation, breaking the frangible portion does not vent the plenum to atmosphere.

In accordance with another implementation, the method includes engaging the plug with a step of the body.

In accordance with another implementation, the cover includes a plug.

In accordance with another implementation, the cover includes foil.

In accordance with another implementation, the cover includes a frangible portion.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 illustrates a schematic diagram of an example implementation of a system, a liquid reservoir, and a cartridge assembly that can be used to implement the system, the liquid reservoir, and the liquid reservoir of FIG. 1.

FIG. 3 illustrates an expanded isometric view of an example implementation of a liquid reservoir that can be used to implement the liquid reservoir of FIG. 1.

FIG. 4 is a cross-sectional isometric view of the liquid reservoir of FIG. 3.

FIG. 5 is a top isometric view of the compliant barrier coupled to the body of the liquid reservoir of FIG. 3.

FIG. 6 is a partial cross-sectional view of an alternative example implementation of a compliant barrier that can be used to implement the compliant barrier of the lid assembly of FIG. 1.

FIG. 7 is a partial cross-sectional view of an alternative example implementation of a compliant barrier that can be used to implement the compliant barrier of the lid assembly of FIG. 1.

FIG. 8 is a bottom isometric view of the lid assembly of FIG. 3 including the compliant barrier.

FIG. 9 is a bottom plan view of the cantilever of FIG. 8.

FIG. 10 is a bottom plan view of another example implementation of a cantilever that can be used to implement the cantilever of FIG. 1.

FIG. 11 is a bottom plan view of another example implementation of a cantilever that can be used to implement the cantilever of FIG. 1.

FIG. 12 is a bottom isometric view of another example implementation of a portion of a lid assembly including the compliant barrier that can be used to implement the lid assembly of FIG. 1.

FIG. 13 illustrates a schematic diagram of an example implementation of a system, a liquid reservoir, and the cartridge assembly that can be used to implement the system, the liquid reservoir, and the liquid reservoir of FIG. 1.

FIG. 14 illustrates a schematic diagram of an implementation of a system and a liquid reservoir that can be used to implement the system and the liquid reservoir of FIG. 1.

FIG. 15 illustrates a schematic diagram of an implementation of the system and a liquid reservoir that can be used to implement the system and the liquid reservoir of FIG. 1.

FIGS. 16-19 illustrate flow charts for methods of using the liquid reservoirs of FIGS. 1-14, the cartridge assembly of FIGS. 1, 2, and 13, and the system of FIGS. 1, 2, 13, 14, and 15 or any of the other disclosed implementations.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

The implementations disclosed herein relate to liquid reservoirs, cartridge assemblies, and related systems. The liquid reservoirs have a plenum and storage chambers each having an opening and containing liquid in some implementations. The plenum may be referred to as a pressurization chamber. The liquid may be liquid reagent.

The opening of the storage chambers may be sealed from the plenum by a cover and/or a plug. The plenum is fluidly coupled to the storage chamber in operation by breaching the cover and/or by moving the plug without venting the plenum to atmosphere and/or without the system directly interfacing with the liquid contained within the storage chamber. The system not directly interfacing with the liquid reduces the likelihood of cross-contamination between reagents and reduces the likelihood of buildup of reagents and/or associated salts within the system that may otherwise occlude flow channels, for example. The system (e.g., a sequencing system) not directly interfacing with the liquid within the storage chambers also allows the system to be less complex and, thus, less expensive. The system may be referred to as a “dry instrument” because the system does not directly interface with the liquid. The systems disclosed herein may still be considered a “dry instrument” if the system has a waste reservoir that receives the liquid from the liquid reservoir.

Some implementations of the liquid reservoir have a body including a top surface, a storage chamber having an opening at the top surface, a sipper chamber having an opening at the top surface, and a fluidic sinus fluidly coupling the storage chamber and the sipper chamber. A cover such as a foil cover covers the opening of the storage chamber. The sipper chamber may be referred to as a fluidic sinus and may be formed between the body and a cover in some implementations. A fluidic sinus of the body couples the storage chamber with an outward-facing groove on a side of the body in such implementations. A cover is secured to the side of the body, and the groove and the cover define a sipper fluidic path.

The liquid reservoir also includes a lid assembly coupled to the top surface. The lid assembly may have a first portion covering the opening of the storage chamber and a second portion covering the opening of the sipper chamber. The top surface and the first portion define a plenum. The first portion of the lid assembly includes a pneumatic port fluidly coupled to the plenum, a cantilever having a distal end, and a compliant barrier covering the cantilever and defining a portion of the plenum. The second portion has a fluidic port fluidly coupled to the opening of the sipper chamber. The compliant barrier and the cantilever are movable in operation to enable the distal end of the cantilever to pierce the cover and allow the storage chamber to be fluidly coupled to the plenum. The cover may be pierced in different ways, however, and the liquid reservoir may not include the cantilever in such implementations.

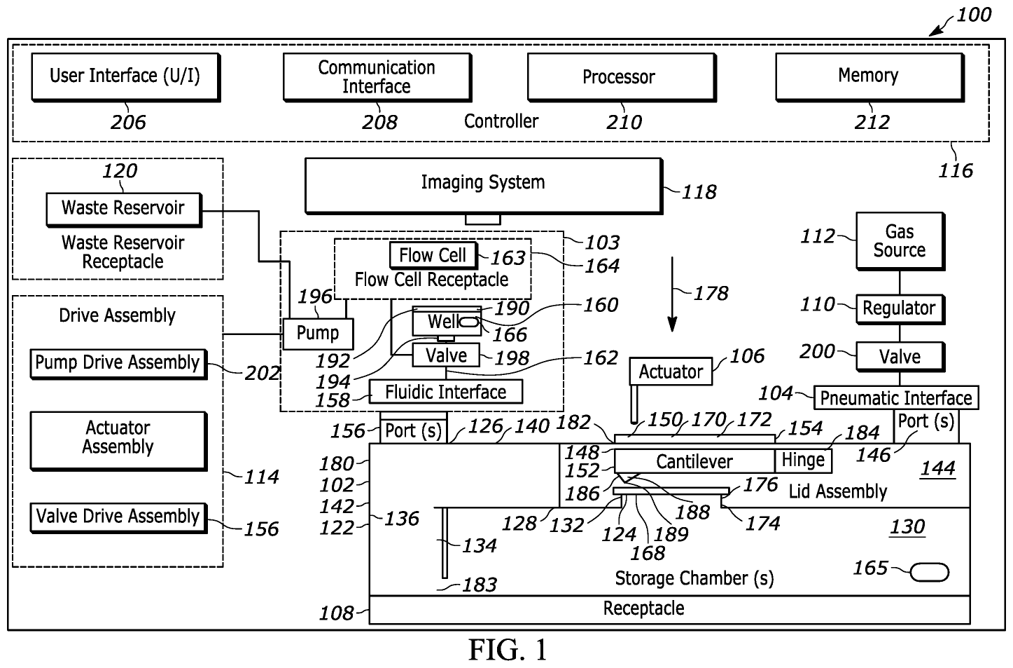

FIG. 1 illustrates a schematic diagram of an implementation of a system 100 in accordance with the teachings of this disclosure. The system 100 can be used to perform an analysis on one or more samples of interest. The sample may include one or more DNA clusters that are linearized to form a single stranded DNA (sstDNA). In the implementation shown, the system 100 receives a liquid reservoir 102 and a cartridge assembly 103 and includes, in part, a pneumatic interface 104, an actuator 106, a receptacle 108, a regulator 110, a gas source 112, a drive assembly 114, a controller 116, an imaging system 118, and a waste reservoir 120. The liquid reservoir 102 may be referred to as a consumable, a reagent reservoir, or a reagent assembly. The waste reservoir 120 may alternatively be carried by the liquid reservoir 102 as an example. The controller 116 is electrically and/or communicatively coupled to the actuator 106, the regulator 110, the drive assembly 114, and the imaging system 118 and causes the actuator 106, the regulator 110, the drive assembly 114, and/or the imaging system 118 to perform various functions as disclosed herein.

The liquid reservoir 102 is receivable within the receptacle 108 and includes a body 122, a cover 124, and a lid assembly 126. The body 122 has a top surface 128 and a storage chamber 130 having an opening 132 at the top surface 128. The body 122 also has a sipper chamber 134 having an opening 136 at the top surface 128 and a fluidic sinus 138 fluidly coupling the storage chamber 130 and the sipper chamber 134. The sipper chamber 134 may be referred to as a sipper fluidic path and/or a sipper channel.

The cover 124 covers the opening 132 of the storage chamber 130 and the lid assembly 126 is coupled to the top surface 128. The lid assembly 128 may be laser welded to the top surface 128 of the liquid reservoir 102. The lid assembly 128 may be coupled to the top surface 128 in different ways, however, including adhesive or using another coupling for example. The cover 124 may be implemented by plastic, foil, rubber, a seal, and/or a plug. The lid assembly 126 has a first portion 140 covering the opening 132 of the storage chamber 130 and a second portion 142 covering the opening 136 of the sipper chamber 134. The top surface 128 of the body 122 and the second portion 142 define a plenum 144.

The first portion 140 of the lid assembly 126 has a pneumatic port 146, a cantilever 148, and a compliant barrier 150. The cantilever 148 and the compliant barrier 150 may be formed using a two-shot molding process in some implementations. The compliant barrier 150 may be formed of a thermoplastic elastomer (TPE) as an example. The compliant barrier 150 may have a thickness of about 0.9 millimeters (mm). The compliant barrier 150 may be made of another material and/or have a different thickness, however.

The pneumatic port 146 is fluidly coupled to the plenum 144. The cantilever 148 may be referred to as a piercer. The cantilever 148 has a distal end 152 and the compliant barrier 150 covers the cantilever 148 and defines a portion 154 of the plenum 144. The second portion 142 includes a fluidic port 156 fluidly coupled to the opening 136 of the sipper chamber 134.

The cartridge assembly 103 has a fluidic interface 158, a well 160, and a channel 162 fluidly coupled between the fluidic interface 158 and the well 160. The fluidic interface 158 is shown coupled to the fluidic port 156 in the implementation shown.

The cartridge assembly 103 also includes a flow cell 163 in the implementation shown. The cartridge assembly 103 may carry the flow cell 163 such that the flow cell 163 is integrated into the cartridge assembly 103. As used herein, a “flow cell” can include a device having a lid extending over a reaction structure to form a flow channel therebetween that is in communication with a plurality of reaction sites of the reaction structure, and can include a detection device that detects designated reactions that occur at or proximate to the reaction sites. The flow cell 163 may carry the sample of interest. The cartridge assembly 103 may alternatively include a flow cell receptacle 164 that receives the flow cell 163.

The actuator 106 is movable to engage the compliant barrier 150 in operation and move the distal end 152 of the cantilever 148 to pierce the cover 124 and allow the storage chamber 130 to be fluidly coupled to the plenum 144. The system 100 can thus indirectly actuate the cantilever 148 without the system 100 compromising and/or accessing an interior of the liquid reservoir 102. The engagement between the actuator 106 and the compliant barrier 150 does not vent the plenum 144 to atmosphere as a result.

Liquid 165 is contained within the storage chamber 130 and dried reagent 166 is contained within the well 160. The liquid 165 may be a rehydrating liquid and/or a wash buffer. The liquid 165 may be a different type of liquid, however. The dried reagent 166 may be lyophilized reagent as an example. The liquid reservoir 102 may include any number of storage chambers 130 including one storage chamber as shown and the cartridge assembly 103 may include any number wells 160 including one well as shown. The number of storage chambers 130 that the liquid reservoir 102 has may correspond to the number of wells 160 that the cartridge assembly 103 has in some examples.

The liquid reservoir 102 and/or the cartridge assembly 103 includes a thermoplastic. The liquid reservoir 102 and/or the cartridge assembly 103 may additionally or alternatively include polypropylene and/or cyclic olefin copolymer (COC) with an over molded Santoprene thermoplastic elastomer (TPE) or another thermoplastic elastomer. Other materials may prove suitable for the liquid reservoir 102 and/or the cartridge assembly 103.

The cover 124 that covers the opening 132 may include foil 168 and the compliant barrier 150 may include an elastomer 170 and/or a conformable foil 172. The foil 168 may be a foil with a lacquer backing for bonding to the thermoplastic of the body 122 in some implementations. The lacquer is a coating applied to the cover 124 that promotes the bonding to the body 122 when heat staked, for example. The elastomer 170 may include rubber. The cover 124 and/or the compliant barrier 150 may additionally or alternatively include plastic. The body 122 of the liquid reservoir 102 includes a port 174 having a distal end 176 that defines the opening 132 in the implementation shown. The cover 124 is coupled to the distal end 176 of the port 174. The cover 124 may alternatively be coupled within the port 174 to seal the port 174, for example. The port 174 may alternatively be omitted.

The foil 168 is pierced by the cantilever 148 in operation prior to the storage chamber 130 being pressurized by the gas source 112, for example. The cantilever 148 piercing the cover 124 may allow the pneumatic interface 104 to pressurize the storage chamber 130. The actuator 106 may engage and move the elastomer 170 and/or the conformable foil 172 in a direction generally indicated by arrow 178 and in turn move the distal end 152 of the cantilever 148 in the direction generally indicated by arrow 178 to pierce the foil 168.

The lid assembly 126 in the implementation shown includes a body 180 having the cantilever 148 and the compliant barrier 150 is coupled to the body 180 and covers the cantilever 148. The body 180 has an aperture 182 and the compliant barrier 150 covers the aperture 182. The aperture 182 may alternatively be referred to as an opening or a window. The actuator 106 can move the cantilever 148 by moving the compliant barrier 150 relative to and/or through the aperture 182. The aperture 182 being larger may reduce an amount of force used to actuate the cantilever 148.

The body 180 has a living hinge 184 coupled to the cantilever 148. The living hinge 184 allows the cantilever 148 to move relative to the remainder of the body 180 and for the cantilever 148 to pierce the cover 124. The cantilever 148 may be movably coupled to the body 180 in different ways, however.

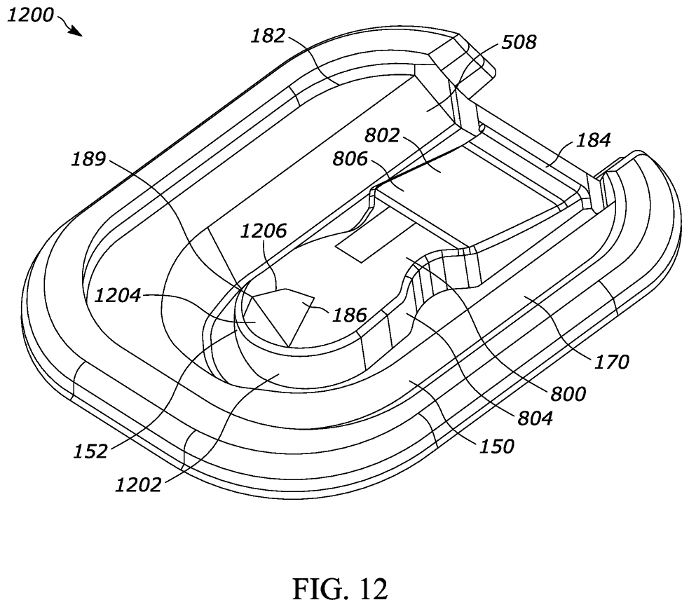

The distal end 152 of the cantilever 148 has a protrusion 186 in the implementation shown. The protrusion 186 may be adapted to pierce the cover 124 and allow the cover 124 to be pneumatically coupled to the plenum 144. The protrusion 186 may be shaped to pierce the cover 124 with a lesser amount of force. The protrusion 186 may be an oblique cone 188. The protrusion 186 being an oblique cone 188 may orient a tip 189 of the protrusion 186 to be substantially perpendicular relative to the cover 124 when the protrusion 186 is actuated to pierce the cover 124. The protrusion 186 may pierce the cover 124 with less force being applied as a result. The protrusion 186 may have any other shape and/or the tip 189 be in any other position, however. For example, the protrusion 186 may be a polyhedron 1204 (see, FIG. 12) such as a pyramid.

The cartridge assembly 103 includes a cover 190 shown covering the well 160. The cover 190 may include and/or form a vent 192 that allows air flow out of the well 160. The vent 192 is sized to substantially retain the dried reagent 166 within the well 160. The use of the dried reagent 166 in the disclosed implementations may simplify storage requirements, reduce shipping costs, and increase the speed of workflows by, for example, avoiding thaw time before the reagent may be used.

The well 160 includes a port 194 and the liquid 165 can flow into the well 160 via the port 194 in practice to rehydrate the dried reagent 166. The vent 192 may vent gas from the well 160 as the liquid 165 flows into the well 160 and the cover 190 prevents or inhibits the dried reagent 166 and/or the liquid 165 from escaping from the well 160. Put another way, the vent 192 retains the dried reagent 166 and/or the liquid 165 within the wells 160 and prevents or inhibits the dried reagent 166 and/or the liquid 165 from migrating out of the wells 160. The vent 192 and the cover 190 prevents or inhibits cross-contamination between reagents when the liquid reservoir 102 includes more than one well 160. The liquid 165 and the dried reagent 166 can be flowed into and out of the well 160 to mix the liquid 165 from the liquid reservoir 102 and the dried reagent 166. The system 100 and/or the liquid reservoir 102 may include a mixing chamber that is used to mix the liquid 165 and the dried reagent 166 in some implementations.

The gas source 112 may be used to pressurize the liquid reservoir 102 to flow the liquid 165 into the well 160 and/or a pump 196 may draw the liquid 165 from the liquid reservoir 102 and flow the liquid 165 into the well 160 to rehydrate the dried reagent 166. The pump 196 may be used to draw the rehydrated reagent from the well 160 to the flow cell 163 in some implementations. The gas source 112 may be provided by the system 100 and/or the gas source 112 may be carried by the liquid reservoir 102. The gas source 112 may alternatively be omitted.

The cartridge assembly 103 may include the pump 196 as shown and/or the pump 196 may be part of the system 100. The pump 196 may alternatively be omitted. The pump 196 may be implemented by a syringe pump, a peristaltic pump, a diaphragm pump, etc. While the pump 196 may be positioned downstream of the flow cell 163 as shown, the pump 196 may be positioned upstream of the flow cell 163 or omitted entirely.

The cartridge assembly 103 is shown including a valve(s) 198 that may be actuatable to control the flow of the liquid 165 from the liquid reservoir 102 to the well 160 and/or the flow cell 163. The valve 198 may be implemented by a three-way valve, a valve manifold, a rotary valve, a selector valve, a pinch valve, a flat valve, a solenoid valve, a check valve, a piezo valve, etc.

The liquid reservoir 102 and/or the system 100 includes a valve 200 that may be selectively actuatable to control the flow of fluid (gas) to the liquid reservoir 102. The valve 200 may be implemented by a valve manifold, a rotary valve, a selector valve, a pinch valve, a flat valve, a solenoid valve, a check valve, a piezo valve, etc. The regulator 110 can be positioned between the gas source 112 and the valve 200 and regulates a pressure of the gas provided to the valve 200. The regulator 110 may be a valve that controls the flow of the gas from the gas source 112.

The gas source 112 and/or the pump 196 may flow the liquid 165 to rehydrate dried reagents 166 and to flow one or more liquid reagents (e.g., A, T, G, C nucleotides) through the liquid reservoir 102 that interact with the sample. The gas source 112 may flow the liquid 165 to rehydrate the dry reagents 166 on the cartridge assembly 103 and the pump 196 on the cartridge assembly 103 may flow the rehydrated reagent (e.g., A, T, G, C nucleotides) to the flow cell 163 that interact with the sample as an example. The reagent with a reversible terminator in an implementation allows a single nucleotide to be incorporated by the sstDNA per cycle. One or more of the nucleotides has a unique fluorescent label in such implementations that emits a color when excited. The color (or absence thereof) is used to detect the corresponding nucleotide. The imaging system 118 excites one or more of the identifiable labels (e.g., a fluorescent label) in the implementation shown and thereafter obtains image data for the identifiable labels. The labels may be excited by incident light and/or a laser and the image data may include one or more colors emitted by the respective labels in response to the excitation. The image data (e.g., detection data) may be analyzed by the system 100. The imaging system 118 may be a fluorescence spectrophotometer including an objective lens and/or a solid-state imaging device. The solid-state imaging device may include a charge coupled device (CCD) and/or a complementary metal oxide semicondusctor (CMOS).

After the image data is obtained, the drive assembly 114 interfaces with the liquid reservoir 102 to flow another reaction component (e.g., a reagent) through the flow cell 163 that is thereafter received by the waste reservoir 120 and/or otherwise exhausted by the cartridge assembly 103. The reaction component performs a flushing operation that chemically cleaves the fluorescent label and the reversible terminator from the sstDNA. The sstDNA is then ready for another cycle.

Referring now to the drive assembly 114, in the implementation shown, the drive assembly 114 includes a pump drive assembly 202 and a valve drive assembly 204. The pump drive assembly 202 interfaces with the pump 196 to pump fluid through the liquid reservoir 102 and/or the flow cell 163 and the valve drive assembly 204 interfaces with the valves 198 and/or 200 to control the position of the valves 198 and/or 200.

Referring to the controller 116, in the implementation shown, the controller 116 includes a user interface 206, a communication interface 208, one or more processors 210, and a memory 212 storing instructions executable by the one or more processors 210 to perform various functions including the disclosed implementations. The user interface 206, the communication interface 208, and the memory 212 are electrically and/or communicatively coupled to the one or more processors 210.

In an implementation, the user interface 206 receives input from a user and provides information to the user associated with the operation of the system 100 and/or an analysis taking place. The user interface 206 may include a touch screen, a display, a keyboard, a speaker(s), a mouse, a track ball, and/or a voice recognition system. The touch screen and/or the display may display a graphical user interface (GUI).

In an implementation, the communication interface 208 enables communication between the system 100 and a remote system(s) (e.g., computers) via a network(s). The network(s) may include an intranet, a local-area network (LAN), a wide-area network (WAN), the intranet, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 210 and/or the system 100 may include one or more of a processor-based system(s) or a microprocessor-based system(s). In some implementations, the one or more processors 210 and/or the system 100 includes a reduced-instruction set computer(s) (RISC), an application specific integrated circuit(s) (ASICs), a field programmable gate array(s) (FPGAs), a field programmable logic device(s) (FPLD(s)), a logic circuit(s), and/or another logic-based device executing various functions including the ones described herein.

The memory 212 can include one or more of a hard disk drive, a flash memory, a read-only memory (ROM), erasable programmable read-only memory (EPROM), electrically erasable programmable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

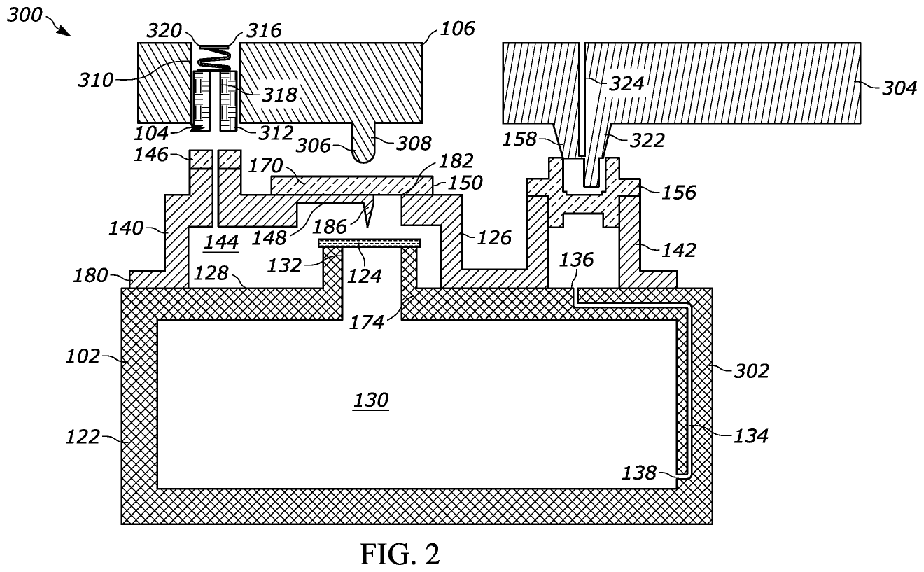

FIG. 2 illustrates a schematic diagram of an example implementation of a system 300, a liquid reservoir 302, and a cartridge assembly 304 that can be used to implement the system 100, the liquid reservoir 102, and the liquid reservoir 102 of FIG. 1. The body 122 is shown defining the sipper chamber 134 in the implementation shown. A side of the body 122 may alternatively define an outward facing groove and a cover may be secured to the side of the body 122 covering the groove. The groove and the cover may form the sipper chamber 134 in such examples. The cover may include a laminate.

The system 300 includes the pneumatic interface 104 and the actuator 106 having an actuator rod 306 having a distal end 308. The pneumatic interface 104 has a bore 310, a coupling 312 movably positioned within the bore 310, and a biasing element 316. The biasing element 316 urges the coupling 312 into sealing engagement with the pneumatic port 146 of the lid assembly 126 in operation. The pneumatic interface 104 can establish a fluidic connection with the liquid reservoir 102 and allow the gas source 112 to pressurize the storage chamber 130 as a result.

The coupling 312 is shown being cylindrical and having a through hole 318. The biasing element 316 is shown as a coil spring 320. The biasing element 316 may be differently configured however and may be implemented by a spring, a rubber spring, a Belleville washer as examples.

The fluidic interface 158 of the cartridge assembly 304 has a hollow protrusion 322 that is positioned within the fluidic port 156 of the lid assembly 126 to fluidly couple the liquid reservoir 102 and the cartridge assembly 103. The hollow protrusion 322 is conical in the implementation shown to facilitate alignment when coupling the liquid reservoir 102 and the cartridge assembly 103, for example. The cartridge assembly 304 includes a fluidic line 324 that may be fluidly coupled to the well 160, for example.

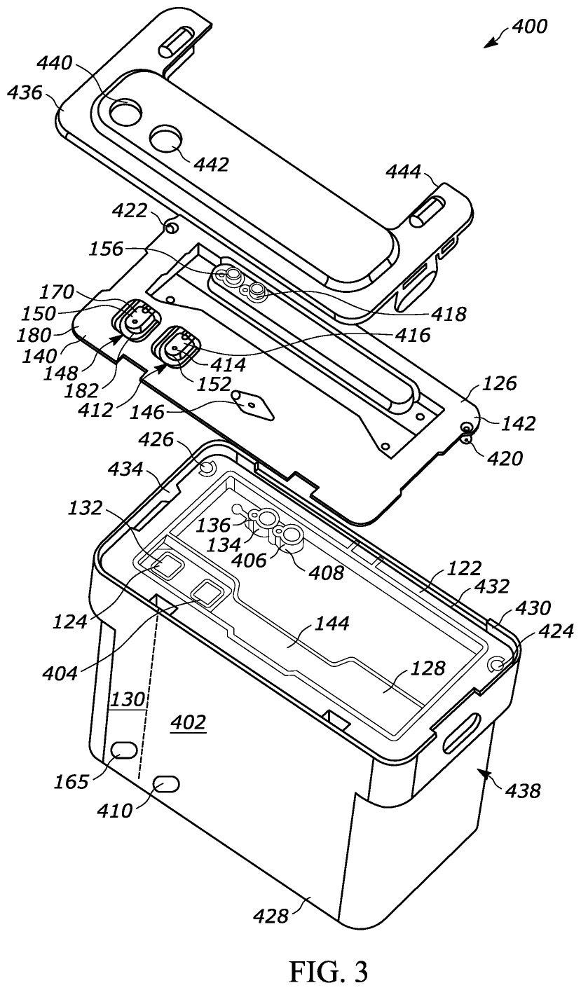

FIG. 3 illustrates an expanded isometric view of an example implementation of a liquid reservoir 400 that can be used to implement the liquid reservoir 102 of FIG. 1. The liquid reservoir 400 of FIG. 3 includes the body 122, the storage chamber 130 having the opening 132 and the cover 124 covering the opening 132 of the storage chamber 130. The body 122 of the liquid reservoir 400 of FIG. 3 also includes a second storage chamber 402 having an opening 404 at the top surface 128, a second sipper chamber 406 having an opening 408 at the top surface 128, and a second fluidic sinus (similar to the fluidic sinus 138) fluidly coupling the second storage chamber 402 and the second sipper chamber 406. The cover 124 is shown covering the opening 404 of the second storage chamber 402. A separate cover may alternatively be used to cover the opening 404 of the second storage chamber 402. The second storage chamber 402 contains liquid 410 in the implementation shown. The liquid 410 may be the same or different from the liquid 165.

The liquid reservoir 400 includes the lid assembly 126 having the first portion 140 that covers the openings 132, 404 of the first and second storage chamber 130, 402 and the second portion 142 that covers the openings 136, 408 of the first and second sipper chambers 134, 406. The body 122 and the lid assembly 126 include a manifold 411 in the implementation shown. The manifold 411 includes the plenum 144 and the openings 132, 404 of the first and second storage chamber 130, 402. The manifold 411 enables one or more of the storage chambers 130, 402 to be pressurized by the system 100, for example.

The first portion 140 of the lid assembly 126 also includes a second cantilever 412 having a distal end 152 and a second compliant barrier 414 that covers the second cantilever 412 and defines a portion 416 of the plenum 144. The second portion 142 of the lid assembly 126 has a second fluidic port 418 that is arranged to be fluidly coupled to the opening 408 of the second sipper chamber 406. The coupling between the fluidic ports 156, 418 and the openings 136, 408 of the sipper chambers 134, 406 allow the liquid 165, 410 to flow from the storage chambers 130, 402 to the cartridge assembly 103 and rehydrate the dried reagent 166, for example.

The lid assembly 126 has a pair of locating pins 420, 422 and the body 122 has a pair of corresponding locating holes 424, 426 in the implementation shown. The locating holes 424, 426 are received within the locating holes 424, 426 to position the cantilevers 148, 412 over top of the cover 124 and the openings 132, 404 and for the fluidic ports 156, 418 to be aligned and/or fluidly coupled with the sipper chambers 134, 406.

The liquid reservoir 400 also includes a housing 428 in the implementation shown in which the body 122 is disposed. The housing 428 has an end 430 defining an opening 432 and the lid assembly 126 is positioned within the housing 428 and accessible via the opening 432. The housing 428 provides a space 434 between the top surface 128 of the body 122 and the end 430 of the housing 428 in which the lid assembly 126 can be positioned.

The liquid reservoir 400 has a housing cover 436 in the implementation shown that is arranged to be coupled the housing 428 and to retain the body 122 and the lid assembly 126 within the housing 428. A snap-fit connection 438 is formed between the housing cover 436 and the housing 428 when the housing cover 436 and the housing 428 are coupled. The housing cover 436 and the housing 428 may be coupled in different ways, however. The housing cover 436 is shown defining an aperture 440 enabling access to the compliant barrier 150 covering the cantilever 148 when the housing cover 436 is coupled to the housing 428. The housing cover 436 also defines a second aperture 442 and includes a cutout 444. The second aperture 442 enables access to the second compliant barrier 414 covering the second cantilever 412 and the cutout 444 enables access to the fluidic ports 156, 418.

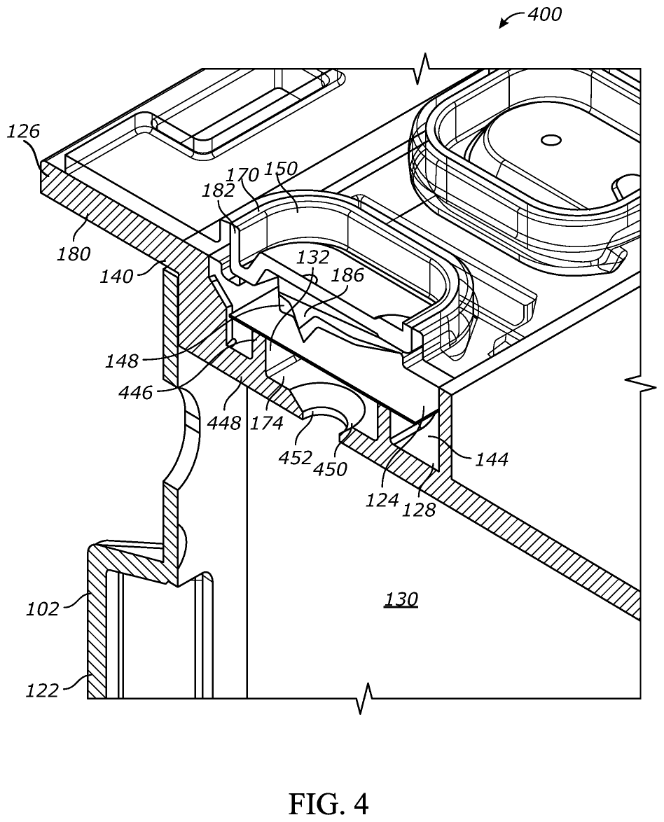

FIG. 4 is a cross-sectional isometric view of the liquid reservoir 400 of FIG. 3. The lid assembly 126 is shown having the body 180 that defines the aperture 132 and the compliant barrier 150 is coupled to the body 180 and covers the aperture 132. The body 180 of the lid assembly 126 also has the port 174 that includes an outer wall 446 and a lower wall 448. The lower wall 448 has a conical portion 450 that defines an aperture 452 that is coupled to the storage chamber 130. The conical portion 450 extends outwardly toward the cover 124. The conical portion 450 may encourage any of the liquid 165 that flows out of the storage container 130 into the port 174 to flow back into the storage container 130 as an example.

FIG. 5 is a top isometric view of the compliant barrier 150 coupled to the body 180 of the liquid reservoir 400 of FIG. 3. The compliant barrier 150 has an outer wall 500, a central portion 502, and a groove 504 that at least partially surrounds the central portion 502. The groove 504 may allow the central portion 502 to be actuated or otherwise moved lower with a lesser amount of force being applied. The outer wall 500 is coupled to the body 180 that surrounds the aperture 182. The compliant barrier 150 has a U-shaped portion 506 that couples the outer wall 500 and the central portion 502. The U-shaped portion 506, the outer wall 500, and the central portion 502 define the groove 504. The central portion 502 also has an outwardly tapered U-shaped wall 508 that defines the groove 504. The U-shaped wall 508 corresponds to and is coupled to the U-shaped portion 506. The central portion 502 has a proximal end 510 that is coupled to the outer wall 500. The outwardly tapered U-shaped portion 506 is shown positioned between the U-shaped wall 508 and the outer wall 500 but the U-shaped portion 506 is not shown positioned between the proximal end 510 and the outer wall 500.

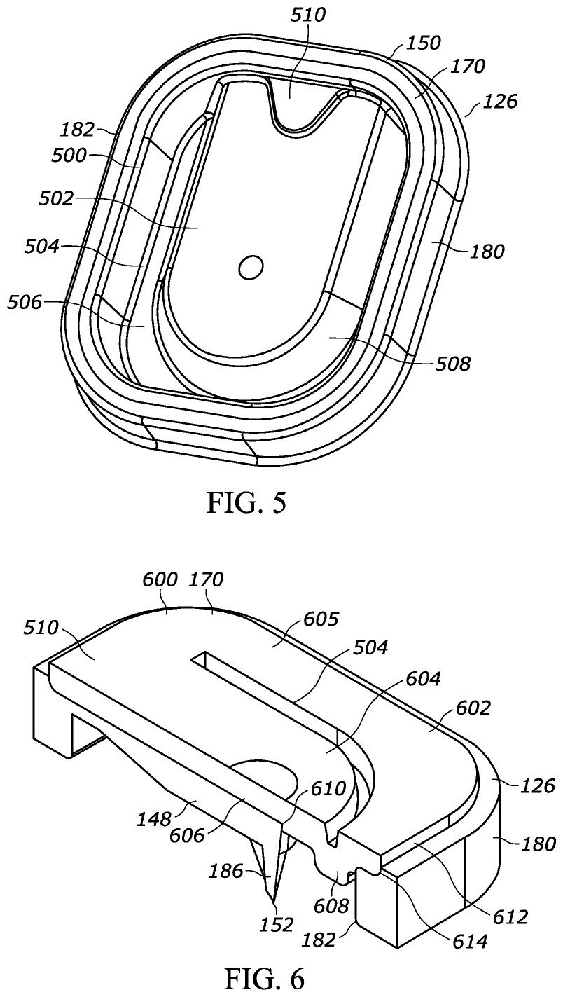

FIG. 6 is a partial cross-sectional view of an alternative example implementation of a compliant barrier 600 that can be used to implement the compliant barrier 150 of the lid assembly 126 of FIG. 1. The compliant barrier 600 includes an outer portion 602, a central portion 604, and the groove 504. The outer portion 602 and the central portion 604 have an exterior surface 605 that are substantially co-planer. The outer portion 602 and the central portion 604 may be vertically spaced, however.

The central portion 604 has a lower surface 606 in the implementation shown and the compliant barrier 600 has a portion 608 defining the groove 504 that is vertically spaced from the lower surface 606. The portion 608 of the compliant barrier 600 is arranged to be positioned closer to the cover 124 covering the opening 132 of the storage chamber 130. The compliant barrier 600 also includes a step 610 in the implementation shown that receives at least a portion of the distal end 152 of the cantilever 148. The compliant barrier 600 also includes a lip 612 and the body 180 includes a groove 614 that receives the lip 612. The lip 612 and/or the groove 614 may alternatively omitted.

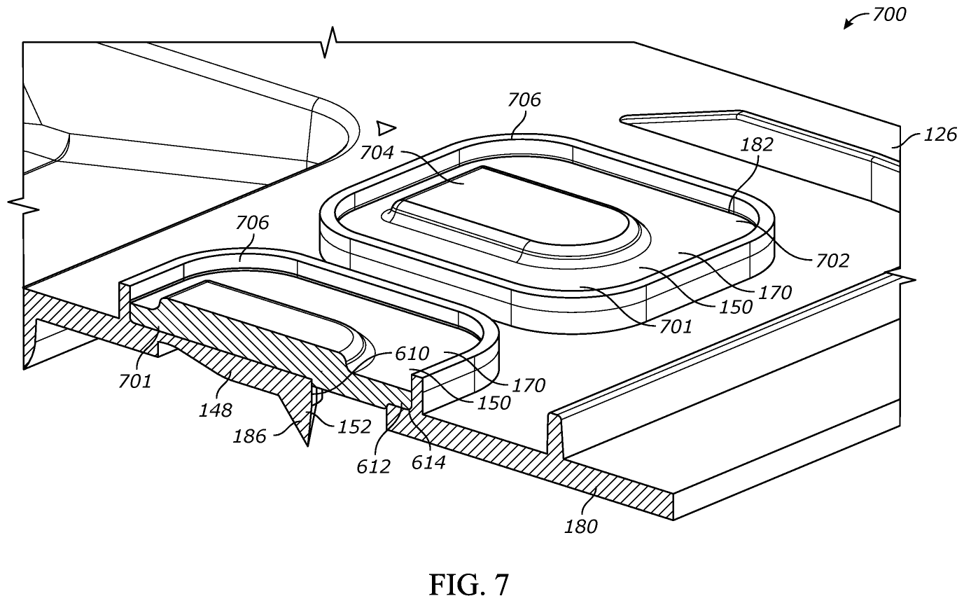

FIG. 7 is a partial cross-sectional view of an alternative example implementation of a lid assembly 700 and a compliant barrier 701 that can be used to implement the compliant barrier 150 of the lid assembly 126 of FIG. 1. The compliant barrier 701 has an outer portion 702 and a central portion 704 that is vertically spaced from the outer portion 702. The outer portion 702 fully surrounds the central portion 704 in the implementation shown. The body 180 of the lid assembly 700 has walls 706 that surround each of the apertures 182 and the corresponding compliant barriers 701.

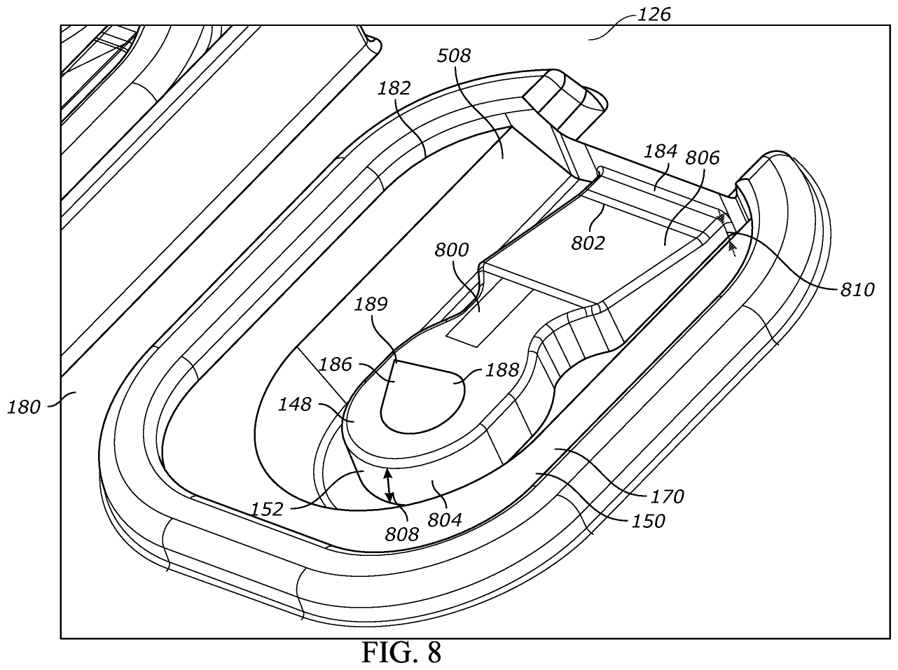

FIG. 8 is a bottom isometric view of the lid assembly 126 of FIG. 3 including the compliant barrier 150. The body 180 of the lid assembly 126 in the implementation shown includes the cantilever 148 and the compliant barrier 150 is coupled to the body 180 and covers the cantilever 148. The cantilever 148 has the distal end 152, a necked portion 800, and a proximal end 802. The necked portion 800 reduces an amount of contact area between the cantilever 148 and the compliant barrier 150 as an example. The body 180 includes the living hinge 184 that is coupled to the proximal end 802 of the cantilever 148.

The distal end 152 has an oblong portion 804. The oblong portion 804 may be a different shape, however. The oblong portion 804 is sized to allow the actuator 106 to easily engage the oblong portion 804. The oblong portion 804 carries the protrusion 186 including the oblique cone 188 in the implementation shown. The tip 189 of the oblique cone 188 is off-center. The protrusion 186 is also closer to the distal end 152 than to the necked portion 800. The tip 189 and/or protrusion 186 may be differently placed, however.

The necked portion 800 has a lesser width as compared to the distal end 152 and the corresponding oblong portion 804. The cantilever 148 has a tapered surface 806 that extends between the necked portion 800 and the living hinge 184. The thickness of the proximal end 802 is less at the coupling between the proximal end 802 and the living hinge 184 than the thickness at the coupling between the proximal end 802 as a result. The thickness of the cantilever 148 may be different than shown, however. The distal end 152 has a first thickness 808 and the proximal end 802 has a second thickness 810 that is less than the first thickness 808. The proximal end 802 having the second thickness 811 forms the living hinge 184.

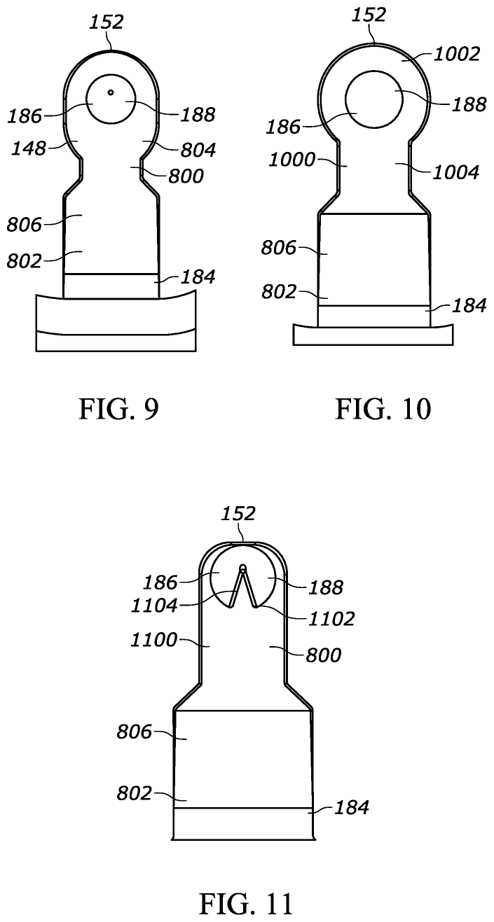

FIG. 9 is a bottom plan view of the cantilever 148 of FIG. 8. The cantilever 148 includes the necked portion 800, the proximal end 802, and the distal end 152 including the oblong portion 804. The length of the cantilever 148 and/or a size of the distal end 152 may affect an amount of force used to actuate the cantilever 148. The cantilever 148 having a longer length and/or the distal end 152 having a larger surface area may reduce an amount of force used the actuate the cantilever 148 as an example.

FIG. 10 is a bottom plan view of another example implementation of a cantilever 1000 that can be used to implement the cantilever 148 of FIG. 1. The cantilever 1000 is similar to the cantilever 148 of FIG. 9. The distal end 152 of the cantilever 1000 of FIG. 10 includes a circular portion 1002 including the protrusion 186, however. The protrusion 186 is shown centrally positioned on the circular portion 1002. The cantilever 1000 also includes a necked portion 1004 that is longer than the necked portion 800 of the cantilever 148 of FIG. 9.

FIG. 11 is a bottom plan view of another example implementation of a cantilever 1100 that can be used to implement the cantilever 148 of FIG. 1. The cantilever 1100 is similar to the cantilever 1000 of FIG. 10. The cantilever 1100 of FIG. 11 omits the circular portion 1002 and the protrusion 186 includes a cut-out 1102 that defines a vent 1104. The vent 1104 enables the storage chamber 130 and the plenum 144 to be fluidly coupled if the protrusion 186 becomes stuck in the cover 124 and/or occludes the piercing in the cover 124 formed by the protrusion 186.

FIG. 12 is a bottom isometric view of another example implementation of a portion of a lid assembly 1200 including the compliant barrier 150 that can be used to implement the lid assembly 128 of FIG. 1. The lid assembly 1200 is similar to the lid assembly 128 of FIG. 1. The lid assembly 1200 of FIG. 12 includes another example implementation of a cantilever 1202, however. The cantilever 1202 includes the protrusion 182 that is implemented by a polyhedron 1204 in the implementation shown. The polyhedron 1204 may alternatively be referred to as a slicer. The polyhedron 1204 is positioned toward the distal end 152 of the cantilever 1202 and includes an edge 1206 and the tip 189. The protrusion 182 thus includes the edge 1206 and the tip 189 in the implementation shown. The tip 189 and the edge 1206 of the polyhedron 1204 are configured to pierce and cut through the cover 124.

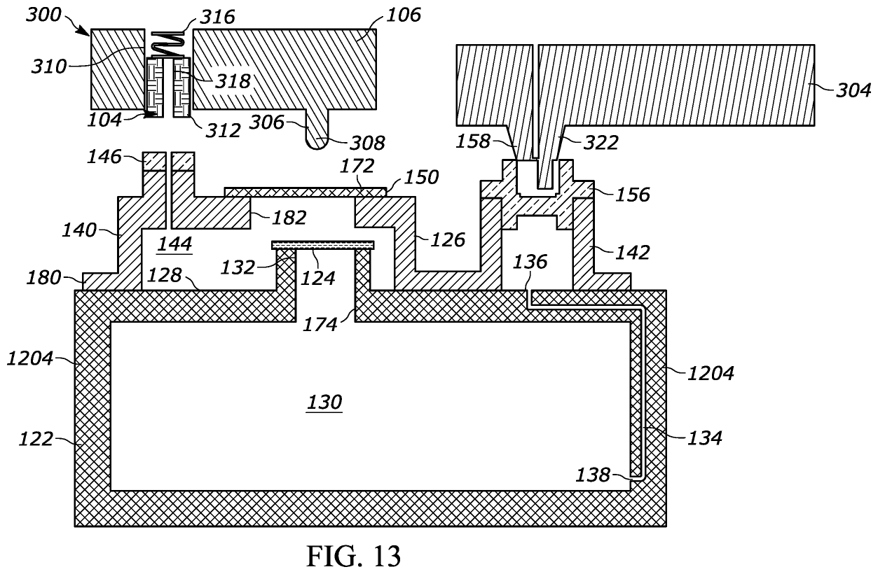

FIG. 13 illustrates a schematic diagram of an example implementation of the system 300, a liquid reservoir 1204, and the cartridge assembly 304 that can be used to implement the system 100, the liquid reservoir 102, and the liquid reservoir 102 of FIG. 1. The liquid reservoir 1204 of FIG. 13 is similar to the liquid reservoir 302 of FIG. 2. The lid assembly 126 of the liquid reservoir 1204 of FIG. 13 does not include the cantilever 148 and the compliant barrier 150 includes the conformable foil 172, however.

The distal end 308 of the actuator rod 306 moves the conformable foil 172 in operation to allow the cover 124 to be pierced and allow the storage chamber 130 to be fluidly coupled to the plenum 144. The conformable foil 172 itself is not pierced during the process of piercing the conformable foil 172. The compliant barrier 150 being pierced does not vent the plenum 144 to atmosphere as a result.

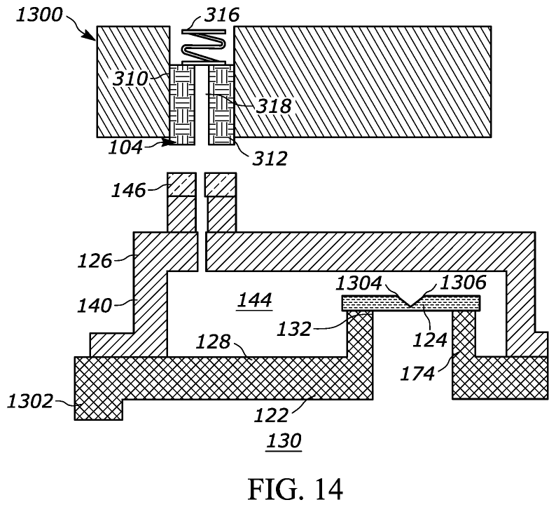

FIG. 14 illustrates a schematic diagram of an implementation of a system 1300 and a liquid reservoir 1302 that can be used to implement the system 100 and the liquid reservoir 102 of FIG. 1. The liquid reservoir 1302 of FIG. 14 is similar to the liquid reservoir 1302 of FIG. 13. The liquid reservoir 1302 of FIG. 14 does not include the compliant barrier 150 and the system 1300 of FIG. 14 does not include the actuator rod 306, however. The liquid reservoir 1302 has the cover 124 that has a frangible portion 1304 and that covers the opening 132 of the storage chamber 130 in the implementation shown.

The plenum 144 is pressurized in operation and the increased pressure breaks the frangible portion 1304 and allows the storage chamber 130 to be fluidly coupled to the plenum 144. The frangible portion 1304 includes a line of weakness 1306 in the implementation shown. The line of weakness 1306 may encourage the frangible portion 1304 to break in response to a pressure increase within the plenum 144. The plenum 144 may not be vented to atmosphere after the frangible portion 1304 is broken.

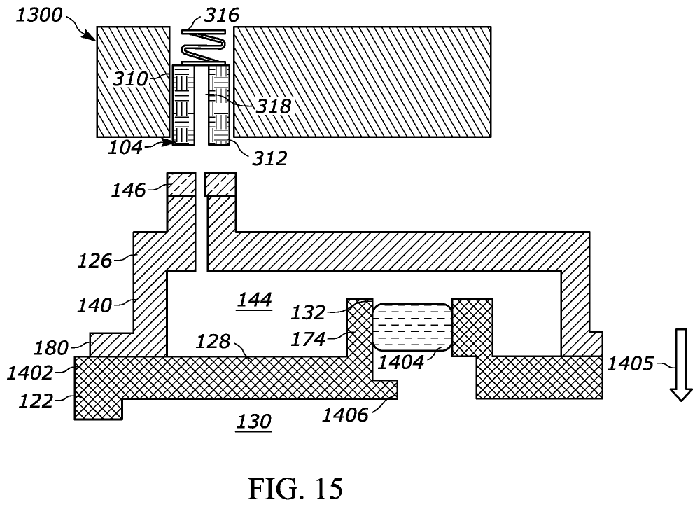

FIG. 15 illustrates a schematic diagram of an implementation of the system 1300 and a liquid reservoir 1402 that can be used to implement the system 100 and the liquid reservoir 102 of FIG. 1. The liquid reservoir 1402 of FIG. 15 is similar to the liquid reservoir 1302 of FIG. 14. The liquid reservoir 1402 of FIG. 15 does not include the foil 168 that covers the opening 132 as an example, however. The liquid reservoir 1402 instead includes a plug 1404 that is disposed in and seals the opening 132 of the storage chamber 130.

The plenum 144 is pressurized in operation and the increased pressure urges the plug 1404 to move within the opening 132 in a direction generally indicated by arrow 1405 and allows the storage chamber 130 to be fluidly coupled to the plenum 144. The body includes a step 1406 to be engaged by the plug 1404. The step 1406 extends into the opening 132 and is positioned to be engaged by the plug 1404. The engagement between the step 1406 and the plug 1404 inhibits the plug 1404 from falling into the storage chamber 130, for example.

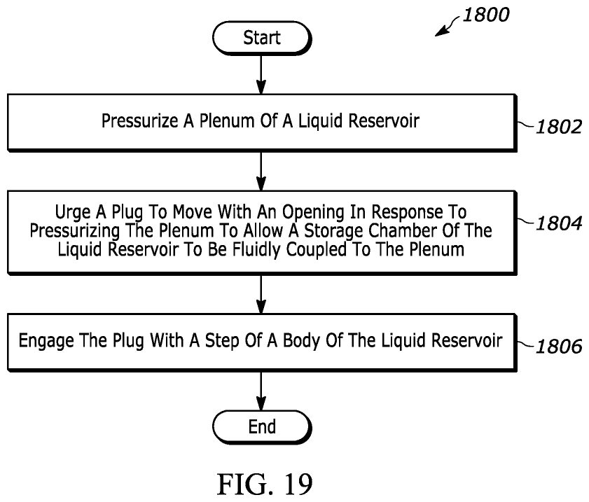

FIGS. 19-19 illustrate flow charts for methods of using the liquid reservoirs 102, 302, 400, 1204, 1302, 1402 of FIGS. 1-14, the cartridge assembly 103 of FIGS. 1, 2, and 12, and the system 100, 300, and 1300 of FIGS. 1, 2, 13, 14, and 15 or any of the other disclosed implementations. The order of execution of the blocks in some implementations may be changed, and/or some of the blocks described may be changed, eliminated, combined and/or subdivided into multiple blocks.

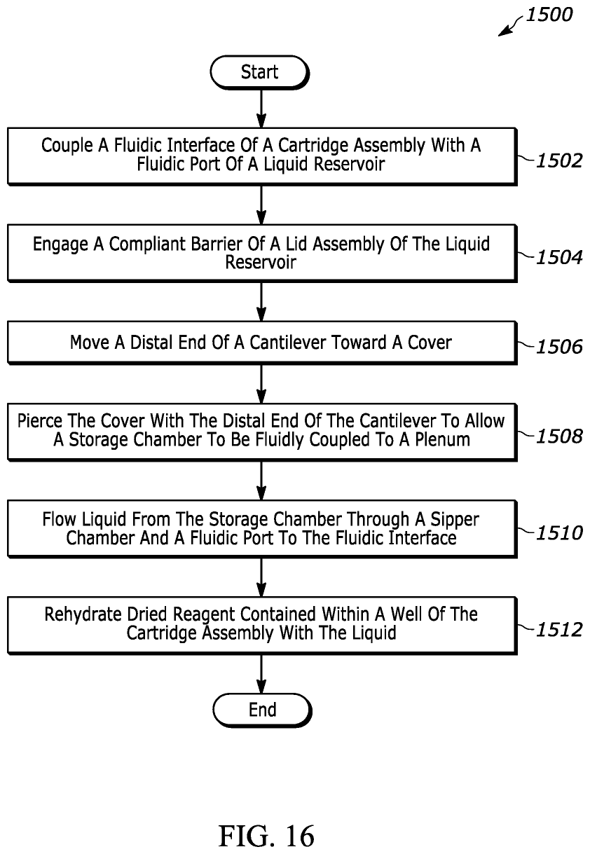

The process 1500 of FIG. 16 begins with the fluidic interface 158 of a cartridge assembly 103 being coupled with the fluidic port 156 of the liquid reservoir 102, 302 (Block 1502). The liquid reservoir 102, 302 has the body 122 defining the storage chamber 130, the sipper chamber 134, and the fluidic sinus 138 fluidly coupling the storage chamber 130 and the sipper chamber 134.

The compliant barrier 150 of the lid assembly 126 of the liquid reservoir 102, 302 is engaged (Block 1504). The liquid reservoir 102, 302 includes the body 122 having the top surface 128 and the storage chamber 130 having the opening 132 at the top surface 128. The liquid reservoir 102, 302 also includes the cover 124 covering the opening 132 of the storage chamber 130 and the lid assembly 126 coupled to the top surface 128 and covering the opening 132 of the storage chamber 130. The top surface 128 and the lid assembly 126 define the plenum 144. The lid assembly 126 includes the cantilever 148 having the distal end 152 and the compliant barrier 150 that covers the cantilever 148 and defines the portion 154 of the plenum 144.

The distal end 152 of the cantilever 148 is moved toward the cover 124 (Block 1506) and the cover 124 is pierced with the distal end 152 of the cantilever 148 to allow the storage chamber 130 to be fluidly coupled to the plenum 144 (Block 1508). The cover 124 being pierced with the distal end 152 of the cantilever 148 does not vent the plenum 144 to atmosphere in some implementations.

Liquid 165 is flowed from the storage chamber 130 through the sipper chamber 134 and the fluidic port 156 to the fluidic interface 158 (Block 1510) and the dried reagent 166 contained within the well 160 of the cartridge assembly 103 is rehydrated with the liquid 165 (Block 1512). The cartridge assembly 103 includes the well 160, the fluidic interface 158, and the channel 162 fluidly coupled between the fluidic interface 158 and the well 160.

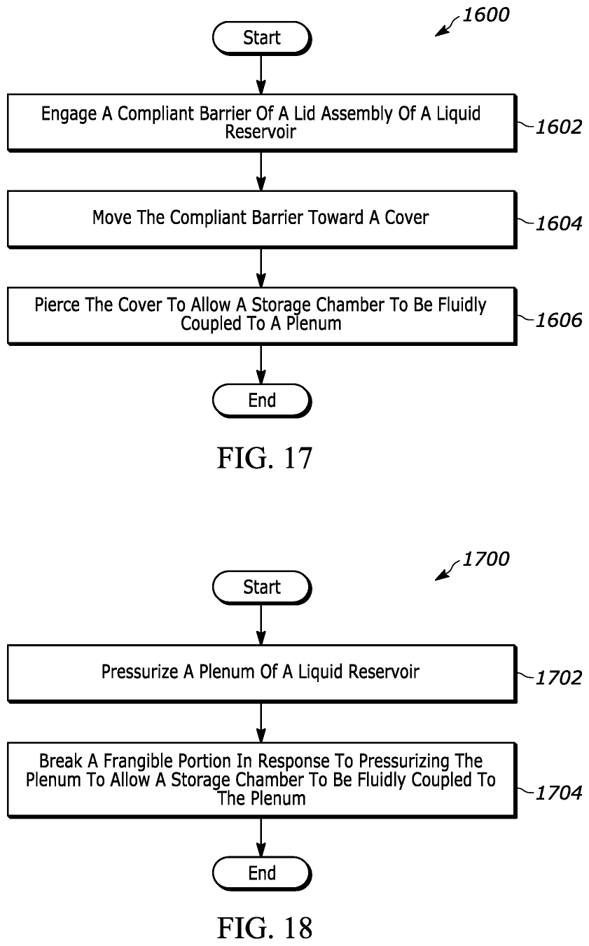

The process 1600 of FIG. 17 begins with the compliant barrier 150 of the lid assembly 126 of the liquid reservoir 102, 1302 being engaged (Block 1602). The liquid reservoir 102, 1204 includes the body 122 having the top surface 128 and the storage chamber 130 having the opening 132 at the top surface 128. The liquid reservoir 102, 1302 also includes the cover 124 covering the opening 132 of the storage chamber 130 and the lid assembly 126 coupled to the top surface 128 and covering the opening 132 of the storage chamber 130. The top surface 128 and the lid assembly 126 define the plenum 144 and the lid assembly 126 includes the compliant barrier 150 that defines the portion 154 of the plenum 144.

The compliant barrier 150 is moved toward the cover 124 (Block 1604) and the cover 124 is pierced to allow the storage chamber 130 to be fluidly coupled to the plenum 144 (Block 1606). The cover 124 being pierced does not vent the plenum 144 to atmosphere. The compliant barrier 150 includes the conformable foil 172 in some implementations. The compliable barrier 150 includes the elastomer 170 in other implementations.

The process 1700 of FIG. 18 begins with the plenum 144 of the liquid reservoir 102, 1302 being pressurized (Block 1702). The liquid reservoir 102, 1302 includes the body 122 having the top surface 128 and the storage chamber 130 has the opening 132 at the top surface 128. The liquid reservoir 102, 1302 also includes the cover 124 having the frangible portion 1304 and that covers the opening 132 of the storage chamber 130 and the lid assembly 126 coupled to the top surface 128. The lid assembly 126 covers the opening 132 of the storage chamber 130. The top surface 128 and the lid assembly 126 define the plenum 144. The frangible portion 1304 breaks in response to pressurizing the plenum 144 to allow the storage chamber 130 to be fluidly coupled to the plenum 144 (Block 1704). The frangible portion 1304 being broken does not vent the plenum 144 to atmosphere in some implementations.

The process 1800 of FIG. 19 begins with the plenum 144 of the liquid reservoir 102, 1402 being pressurized (Block 1802). The liquid reservoir 102, 1402 has the body 122 including the top surface 128 and the storage chamber 130 has the opening 132 at the top surface 128. The liquid reservoir 102, 1402 also includes the lid assembly 126 coupled to the top surface 128 and that covers the opening 132 of the storage chamber 130 and the plug 1404 that is disposed in and sealing the opening 132 of the storage chamber 130. The top surface 128 and the lid assembly 126 define the plenum 144.

The plug 1404 is urged to move within the opening 132 in response to pressurizing the plenum 144 to allow the storage chamber 130 to be fluidly coupled to the plenum 144 (Block 1804). The plug 1404 engages the step 1406 of the body 122 (Block 1806). The engagement between the plug 1404 and the step 1406 may deter the plug 1404 from entering the storage chamber 130, for example.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

While cartridges and reservoirs are described herein with regard to reagent cartridges and reagent reservoirs, these cartridges or reservoirs may also be used to house other liquids, including without limitation buffers, samples, and washes, either separate from or in combination with reagents or other liquids. For example, a cartridge may have a first chamber housing a reagent, a second chamber housing a buffer, and a third chamber housing a wash. Furthermore, the cartridges and reservoirs described herein may include one or more additional chambers that may be used, for example, as waste chambers on the cartridge that may or may not include corresponding sipper chambers.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including, “having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The terms “connect,” “connected,” “contact,” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a system, comprising:
a pneumatic interface;
an actuator; and
a receptacle;
a liquid reservoir receivable within the receptacle and having:
a body comprising a top surface, a storage chamber having an opening at the top surface, a sipper chamber having an opening at the top surface, and a fluidic sinus fluidly coupling the storage chamber and the sipper chamber;
a cover covering the opening of the storage chamber; and
a lid assembly coupled to the top surface and having a first portion covering the opening of the storage chamber and a second portion covering the opening of the sipper chamber, the top surface and the first portion defining a plenum,
the first portion comprising:
a pneumatic port fluidly coupled to the plenum;
a cantilever having a distal end; and
a compliant barrier covering the cantilever and defining a portion of the plenum; and
the second portion comprising a fluidic port fluidly coupled to the opening of the sipper chamber, and
a cartridge assembly, comprising:
a fluidic interface couplable to the fluidic port;
a well; and
a channel fluidly coupled between the fluidic interface and the well,
wherein the actuator is movable to engage the compliant barrier and move the distal end of the cantilever to pierce the cover and allow the storage chamber to be fluidly coupled to the plenum.

2. The apparatus of claim 1, wherein the engagement between the actuator and the compliant barrier does not vent the plenum to atmosphere.

3-4. (canceled)

5. The apparatus of claim 1, wherein the cartridge assembly comprises a flow cell.

6. (canceled)

7. The apparatus of claim 1, wherein the compliant barrier comprises an elastomer or conformable foil.

8. (canceled)

9. The apparatus of claim 1, wherein the body of the liquid reservoir comprises a port having a distal end and defining the opening and wherein the cover is coupled to the distal end of the port.

10. The apparatus of claim 1, wherein the lid assembly comprises a body comprising the cantilever and wherein the compliant barrier is coupled to the body covering the cantilever.

11. (canceled)

12. The apparatus of claim 1, wherein the distal end of the cantilever comprises a protrusion comprising at least one of an oblique cone, a polyhedron, or an edge and a tip.

13. (canceled)

14. The apparatus of claim 1, wherein the pneumatic interface comprises a bore, a coupling movably positioned within the bore, and a biasing element, the biasing element to urge the coupling into sealing engagement with the pneumatic port of the lid assembly and wherein the fluidic interface of the reagent cartridge comprises a hollow protrusion that is positionable within the fluidic port of the lid assembly to fluidly couple the liquid reservoir and the cartridge assembly.

15. (canceled)

16. The apparatus of claim 1, wherein a side of the body defines an outward-facing groove, further comprising a cover secured to the side of the body, the groove and the cover defining the sipper chamber.

17. An apparatus, comprising:
a body comprising a top surface, a storage chamber having an opening at the top surface, a sipper chamber having an opening at the top surface, and a fluidic sinus fluidly coupling the storage chamber and the sipper chamber;
a cover covering the opening of the storage chamber; and
a lid assembly coupled to the top surface and having a first portion covering the opening of the storage chamber and a second portion covering the opening of the sipper chamber, the top surface and the first portion defining a plenum,
the first portion comprising:
a pneumatic port fluidly coupled to the plenum;
a cantilever having a distal end; and
a compliant barrier covering the cantilever and defining a portion of the plenum;
the second portion comprising a fluidic port fluidly coupled to the opening of the sipper chamber,
wherein the compliant barrier and the cantilever are movable to enable the distal end of the cantilever to pierce the cover and allow the storage chamber to be fluidly coupled to the plenum.

18. The apparatus of claim 17, wherein the body comprises a second storage chamber having an opening at the top surface, a second sipper chamber having an opening at the top surface, and a second fluidic sinus fluidly coupling the second storage chamber and the second sipper chamber, wherein the body and the lid assembly comprise a manifold comprising the plenum, the opening of the storage chamber, and the opening of the second storage chamber.

19-21. (canceled)

22. The apparatus of claim 17, further comprising a housing in which the body is disposed, the housing having an end defining an opening, the lid assembly positioned within the housing and accessible via the opening, further comprising a housing cover coupled to the housing and retaining the body and the lid assembly within the housing.

23-25. (canceled)

26. The apparatus of claim 17, wherein the lid assembly comprises a body defining an opening and wherein the compliant barrier is coupled to the body and covers the opening and wherein the compliant barrier comprises an outer wall, a central portion, and a groove at least partially surrounding the central portion, the outer wall coupled to the body surrounding the aperture.

27. The apparatus of claim 26, wherein the compliant barrier comprises an outer wall, a central portion, and a groove at least partially surrounding the central portion, the outer wall coupled to the body surrounding the aperture.

28. The apparatus of claim 26, wherein the compliant barrier comprises a U-shaped portion that couples the outer wall and the central portion, the U-shaped portion, the outer wall, and the central portion defining the groove.

29. The apparatus of claim 26, wherein the central portion comprises an outwardly tapered U-shaped wall that defines the groove.

30. The apparatus of claim 26, wherein the central portion comprises a lower surface and wherein the compliant barrier has a portion defining the groove that is vertically spaced from the lower surface and positioned closer to the cover covering the opening of the storage chamber.

31. The apparatus of claim 26, wherein the compliant barrier comprises an outer portion and a central portion that is vertically spaced from the outer portion, the outer portion coupled to the body surrounding the opening.

32. The apparatus of claim 17, wherein the lid assembly comprises a body comprising the cantilever and wherein the compliant barrier is coupled to the body covering the cantilever, wherein the cantilever comprises the distal end, a necked portion, and a proximal end, the body comprises a living hinge coupled to the proximal end of the cantilever.

33. (canceled)

34. The apparatus of claim 32, wherein the distal end has an oblong portion, wherein the cantilever has a tapered surface that extends between the necked portion and the living hinge, and wherein the distal end has a first thickness and the proximal end has a second thickness that is less than the first thickness.

35-36. (canceled)

37. The apparatus of claim 17, wherein the distal end of the cantilever comprises a protrusion comprising at least one of a cut-out defining a vent, an oblique cone, a polyhedron, or an edge and a tip.

38-74. (canceled)
